(19) United States
(12) Patent Application Publication
(10) Pub. No.: US 2012/0233401 A1
(43) Pub. Date: Sep. 13, 2012

(54) EMBEDDED MEMORY SYSTEM

(75) Inventors: Hsingho LIU, Hsinchu City (TW); Fuja SHONE, Hsinchu City (TW); Chuang CHENG, Hsinchu City (TW); Yu-Shuen TANG, Hsinchu City (TW)

(73) Assignee: SKYMEDI CORPORATION, Hsinchu City (TW)

(21) Appl. No.: 13/043,334

(22) Filed: Mar. 8, 2011

(51) Int. Cl. G06F 12/00

(52) U.S. Cl. 711/115; 711/148; 711/E12.001

(57) ABSTRACT

An embedded memory system is disclosed. A main interface is configured to communicate with an electronic system via a main bus. A memory-sharing auxiliary interface is configured to communicate with the electronic system via a memory-sharing auxiliary bus. An arbiter is configured to arbitrate among the main interface, the memory-sharing auxiliary interface, a primary memory, and a secondary memory. Accordingly, the electronic system is capable of sharing either the primary memory or the secondary memory via the memory-sharing auxiliary interface and the memory-sharing auxiliary bus, and the embedded memory system is capable of sharing a system memory of the electronic system via the memory-sharing auxiliary interface and the memory-sharing auxiliary bus.

### BACKGROUND OF THE INVENTION

1. Field of the Invention

The present invention generally relates to an embedded memory system, and more particularly to a memory card with a volatile memory capable of being shared with an electronic system.

2. Description of Related Art

A memory card, such as a Secure Digital (SD) card, is a non-volatile memory storage device commonly used in company with an electronic system, such as a mobile phone, to retain data without power.

A modern memory card is normally equipped with volatile memory, such as dynamic random access memory (DRAM), for temporarily storing some data. The electronic system mentioned above is also normally equipped with volatile or non-volatile memory for storing some temporary parameters.

It is observed that the volatile memory in the modern memory card is seldom used to the full. It is also noted that it is not uncommon that the electronic system with limited resource such as the mobile phone may sometimes be short of memory space to store more data, thereby degrading its operating speed. On the other hand, an outdated memory card may probably have inadequate memory space, while a state-of-the-art mobile phone may have a relatively large amount of memory. The situation becomes more complicated when the deficiency of the memory space is dynamically situated in either the memory card or the electronic system according to their current operating conditions.

In either case, the surplus memory space more than needed at one side is not helpful to the other side that is short of memory space, thereby causing the memory waste. The underlying rationale of this problem lies in the lack of good communication scheme between the memory card and the associated electronic system to adaptively share the surplus memory space.

For the reason that conventional memory cards and associated electronic systems could not effectively use their memory resources, a need has arisen to propose a novel scheme for dynamically sharing the memory resources between the memory cards and the associated electronic systems.

### SUMMARY OF THE INVENTION

In view of the foregoing, it is an object of the embodiment of the present invention to provide an embedded memory system that is capable of effectively coordinating memory-sharing between the memory resources between the embedded memory system and an associated electronic system.

According to one embodiment, an embedded memory system includes a main interface, a memory-sharing auxiliary interface, a primary memory, a secondary memory, and an arbiter. The main interface is configured to communicate with an electronic system via a main bus. The memory-sharing auxiliary interface is configured to communicate with the electronic system via a memory-sharing auxiliary bus. The arbiter is configured to arbitrate among the main interface, the memory-sharing auxiliary interface, the primary memory, and the secondary memory. Accordingly, the electronic system is capable of sharing either the primary memory or the secondary memory via the memory-sharing auxiliary interface and the memory-sharing auxiliary bus, and the embedded memory system is capable of sharing a system memory of the electronic system via the memory-sharing auxiliary interface and the memory-sharing auxiliary bus.

### BRIEF DESCRIPTION OF THE DRAWINGS

FIG. 1 shows a block diagram of an embedded memory system electrically coupled with an electronic system according to one embodiment of the present invention;

FIG. 2A shows a timing diagram illustrative of a request signal and an acknowledge signal according to one communication pattern;

FIG. 2B shows another timing diagram illustrative of the request signal and the acknowledge signal according to another communication pattern;

FIG. 2C shows a further timing diagram illustrative of the request signal and the acknowledge signal according to a further communication pattern; and

FIG. 3 shows a flow diagram illustrative of communication flow between the embedded memory system and the electronic system according to one embodiment of the present invention.

### DETAILED DESCRIPTION OF THE INVENTION

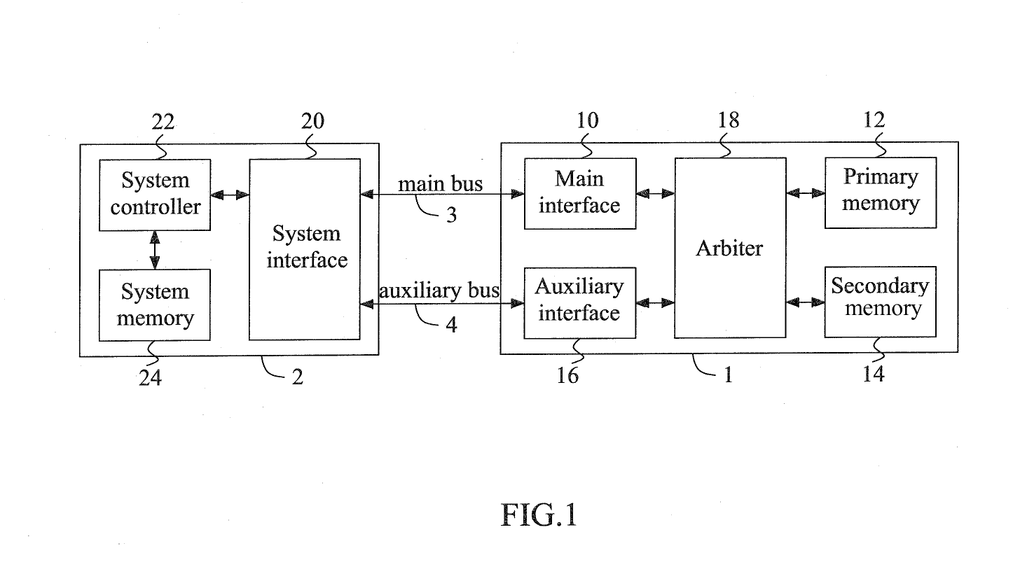

FIG. 1 shows a block diagram of an embedded memory system 1 electrically coupled with an electronic system 2 according to one embodiment of the present invention. In the embodiment, the embedded memory system 1 may be, but is not limited to, a memory card such as an Embedded MultiMediaCard (eMMC) or a Secure Digital (SD) card, or may be a solid-state drive (SSD). The electronic system 2 may be, but is not limited to, a system on chip (SOC) or a system in package (SIP).

Specifically, the embedded memory system 1 includes a main interface 10 that communicates with a system interface 20 via a main bus 3 and an associated protocol. Take eMMC for example, the main interface 10, the system interface 20, and the main bus 3 are compliant with eMMC for exchanging data between the embedded memory system 1 and the electronic system 2. The embedded memory system 1 includes a primary memory 12, which is commonly a non-volatile memory such as flash memory. In addition to the primary memory 12, the embedded memory system 1 also includes a secondary memory 14, which is, in the embodiment, a volatile memory such as dynamic random access memory (DRAM). The electronic system 2 commonly includes a system controller 22 (such as a microprocessor) and a system memory 24 (such as DRAM or flash memory).

According to one aspect of the embodiment, the embedded memory system 1 includes a memory-sharing auxiliary interface (“auxiliary interface” for short hereinafter) 16 that is capable of communicating with the system interface 20 via a memory-sharing auxiliary bus (“auxiliary bus” for short hereinafter) 4.

According to another aspect of the embodiment, the embedded memory system 1 includes an arbiter 18 that arbitrates among the main interface 10, the auxiliary interface 16, the primary memory 12, and the secondary memory 14. Accordingly, the electronic system 2 may access either the primary memory 12 or the secondary memory 14 via either the main interface 10 (and the main bus 3) or the auxiliary interface 16 (and the auxiliary bus 4). On the other hand, the embedded memory system 1, such as a memory controller (not shown) may access the system memory 24 via either the main interface 10 (and the main bus 3) or the auxiliary interface 16 (and the auxiliary bus 4).

According to the architecture of the embodiment, the memory resources, i.e., the primary memory 12, the secondary memory 14, and the system memory 24 may be efficiently shared between the embedded memory system 1 and the electronic system 2. In order to prevent some precious or protected memory area of the memory resources from being intruded or resulted in abnormal operation, the arbiter 18 may limit access range of the memory resource through the auxiliary bus 4.

In the embodiment, the main bus 3 is compliant with a non-proprietary protocol (being either public-domain or licensed protocol) such as eMMC, while the auxiliary bus 4 is a proprietary protocol that may be designed in accordance with specific application. In the embodiment, the auxiliary bus 4 is configured to carry address signals, data signals, and command signals. The formats of the address signals and the data signals may be similar to or the same as those of conventional protocols. In the embodiment, the electronic system 2 and the embedded memory system 1 establish a communication session in a handshaking manner via the command signals. The command signals of the embodiment include a request signal (issued from a host or master) and an acknowledge signal (issued from a slave). It is noted that one of the electronic system 2 and the embedded memory system 1 may act as the host, and the other of the electronic system 2 and the embedded memory system 1 may act as the slave.

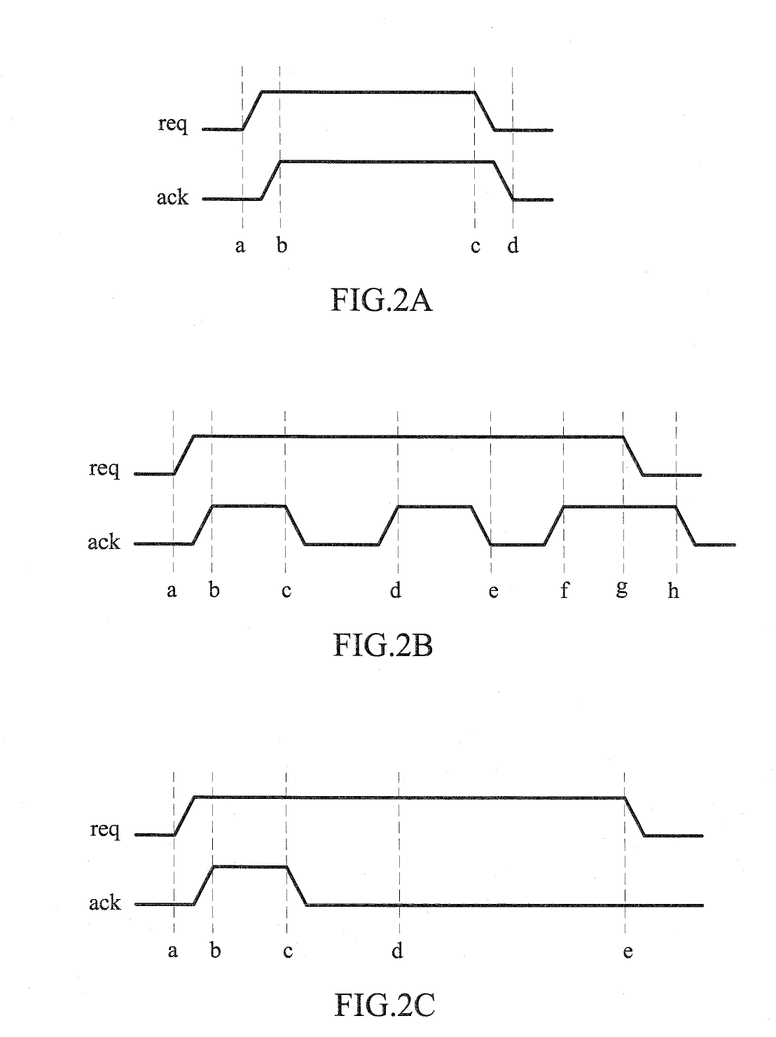

FIG. 2A shows a timing diagram illustrative of the request signal req and the acknowledge signal ack according to one communication pattern. Specifically speaking, after the host asserts (for example, by pulling high) the request signal req at time a, the slave responds with the asserted acknowledge signal ack at time b, which begins a data transfer. The data transfer ends at time c with the de-asserted (for example, pulled-low) request signal req, and the slave responds with the de-asserted acknowledge signal ack, thereby finishing a full data transfer.

FIG. 2B shows another timing diagram illustrative of the request signal req and the acknowledge signal ack according to another communication pattern. In this case, for example, when the slave's buffer (not shown) is full or empty, the slave temporarily interrupts the data transfer by de-asserting the acknowledge signal ack at time c and e respectively. The slave may resume the data transfer at time d and f by asserting again the acknowledge signal ack, when such temporary condition disappears.

FIG. 2C shows a further timing diagram illustrative of the request signal req and the acknowledge signal ack according to a further communication pattern. In this case, for example, when the slave is busy with another more urgent task, the slave prematurely ends the data transfer by de-asserting the acknowledge signal ack at time c and never resumes the data transfer. In order to prevent the host from being waiting permanently, the host is equipped with a timer, which will notify the controller (e.g., the system controller 22 of the electronic system 2 or the arbiter 18 of the embedded memory system 1) of the host after a predefined period (e.g., period between time c and time e) has elapsed. Accordingly, the host unidirectionally ends the data transfer by de-asserting the request signal req at time e.

According to the elementary signaling patterns as illustrated above, the memory sharing between the embedded memory system 1 and the electronic system 2 may be effectively achieved without complicated circuitry. Although the request signal req and the acknowledge signal ack are utilized in the embodiment to end the data transfer, it is appreciated by those skilled in the pertinent art that the data transfer ending may be accomplished via an individual terminating signal instead.

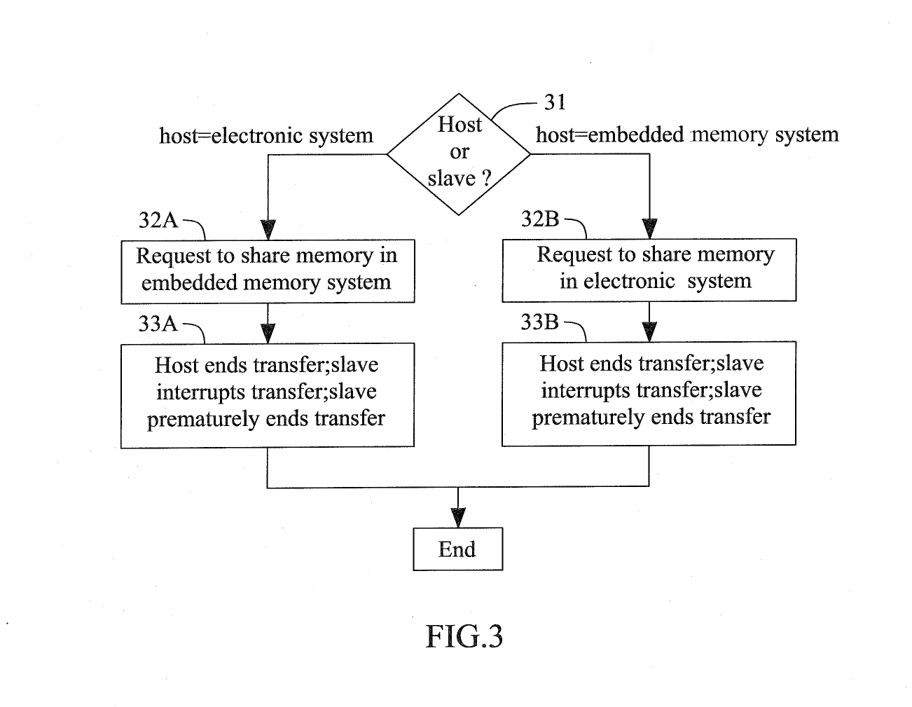

FIG. 3 shows a flow diagram illustrative of communication flow between the embedded memory system 1 and the electronic system 2 according to one embodiment of the present invention.

Specifically, in step 31, it is determined which one of the embedded memory system 1 and the electronic system 2 will act as the host and the other as the slave. In the embodiment, the electronic system 2 determines the host/slave via the main bus 3. Take eMMC for example, the electronic system 2 determines the host/slave via eMMC bus (i.e., the main bus 3).

When the electronic system 2 acts as the host, in step 32A, the electronic system 2 requests the arbiter 18 to share the secondary memory 14 or the primary memory 12 by issuing the asserted request signal req (time a in FIG. 2A), and the embedded memory system 1 responds with the asserted acknowledge signal ack (time b in FIG. 2A), thereby commencing the data transfer between the host and the slave.

Subsequently, in step 33A, the host (i.e., the electronic system 2) may end the data transfer by de-asserting the request signal req (time c in FIG. 2A); or the slave (i.e., the embedded memory system 1) may temporarily interrupt and resume the data transfer (FIG. 2B); or the slave may prematurely end the data transfer (FIG. 2C). Meanwhile, the electronic system 2 may check status (e.g., busy or interruption status) of the embedded memory system 1 via the main bus 3, when necessary, by examining some registers reserved for the protocol (e.g., eMMC) associated with the main bus 3.

In a similar manner, when the embedded memory system 1 acts as the host, in step 32B, the embedded memory system 1 requests to share the system memory 24 via the arbiter 18 by issuing the asserted request signal req (time a in FIG. 2A), and the electronic system 2 responds with the asserted acknowledge signal ack (time b in FIG. 2A), thereby commencing the data transfer between the host and the slave.

Subsequently, in step 33B, the host (i.e., the embedded memory system 1) may end the data transfer by de-asserting the request signal req (time c in FIG. 2A); or the slave (i.e., the electronic system 2) may temporarily interrupt and resume the data transfer (FIG. 2B); or the slave may prematurely end the data transfer (FIG. 2C). Meanwhile, the electronic system 2 may check status (e.g., busy or interruption status) of the embedded memory system 1 via the main bus 3, when necessary, by examining some registers reserved for the protocol (e.g., eMMC) associated with the main bus 3.

Although specific embodiments have been illustrated and described, it will be appreciated by those skilled in the art that various modifications may be made without departing from the scope of the present invention, which is intended to be limited solely by the appended claims.

What is claimed is:

1. An embedded memory system, comprising:
a main interface configured to communicate with an electronic system via a main bus;
a memory-sharing auxiliary interface configured to communicate with the electronic system via a memory-sharing auxiliary bus;
a primary memory;
a secondary memory; and
an arbiter configured to arbitrate among the main interface, the memory-sharing auxiliary interface, the primary memory and the secondary memory, thereby the electronic system being capable of sharing either the primary memory or the secondary memory via the memory-sharing auxiliary interface and the memory-sharing auxiliary bus, and the embedded memory system being capable of sharing a system memory of the electronic system via the memory-sharing auxiliary interface and the memory-sharing auxiliary bus.

2. The embedded memory system of claim 1, wherein the embedded memory system is a memory card or a solid-state drive.

3. The embedded memory system of claim 2, wherein the memory card is an Embedded MultiMediaCard (eMMC) or a Secure Digital (SD) card.

4. The embedded memory system of claim 1, wherein the electronic system is a system on chip or a system in package.

5. The embedded memory system of claim 1, wherein the primary memory is a non-volatile memory and the secondary memory is a volatile memory.

6. The embedded memory system of claim 1, wherein the memory-sharing auxiliary bus is configured to carry address signals, data signals and command signals.

7. The embedded memory system of claim 6, wherein, the command signals comprise a request signal issued from a host and an acknowledge signal issued from a slave, wherein one of the electronic system and the embedded memory system acts as the host and the other of the electronic system and the embedded memory system acts as the slave.

8. The embedded memory system of claim 7, wherein the host or the slave is determined by the electronic system via the main bus.

9. The embedded memory system of claim 7, wherein the host asserts the request signal, followed by the slave's asserting the acknowledge signal, thereby beginning a data transfer.

10. The embedded memory system of claim 9, wherein the data transfer is finished by the host's de-asserting the request signal, followed by the slave's de-asserting the acknowledge signal.

11. The embedded memory system of claim 9, wherein the data transfer is interrupted by the slave's de-asserting the acknowledge signal, followed by the slave's asserting the acknowledge signal to resume the data transfer.

12. The embedded memory system of claim 9, wherein the data transfer is prematurely ended by the slave's de-asserting the acknowledge signal.

13. The embedded memory system of claim 12, wherein the host comprises a timer configured to notify the host after a predetermined period has elapsed since the slave's prematurely ending the data transfer.

14. The embedded memory system of claim 9, wherein the electronic system checks status of the embedded memory system via the main bus by examining at least one register reserved for a protocol associated with the main bus.
